(19) United States
(12) Patent Application Publication
(10) Pub. No.: US 2024/0211213 A1
(43) Pub. Date: Jun. 27, 2024

(54) POPULATING ENTROPY POOL WITH ENTROPY FROM EXTERNAL SOURCES

(71) Applicant: VMware, Inc., Palo Alto, CA (US)

(72) Inventors: Ashok Banerjee, Bloomington, MN (US); Bishakha Banerjee, Los Altos Hills, CA (US); Ravikiran Thirumalai, Palo Alto, CA (US); Ravi Jagannathan, Palo Alto, CA (US)

(21) Appl. No.: 18/087,674

(22) Filed: Dec. 22, 2022

(51) Int. Cl. G06F 7/58; G06F 9/4401; G06F 9/50

(52) U.S. Cl. CPC G06F 7/588; G06F 9/4401; G06F 9/5016

(57) ABSTRACT

To populate an entropy pool with entropy from external sources, a computer system transmits, to multiple entropy sources, a request to receive entropy. At least one of the multiple entropy sources is an external source that is external and operatively connected to the computer system. The computer system receives entropy from the external source. The computer system stores the entropy received from the external source in an entropy storage medium. The computer system receives, from a client computer system, a request for entropy to be used by the client computer system to implement a random number generation algorithm. In response to receiving the request, the computer system provides a portion of the stored entropy. The portion of the stored entropy provided in response to receiving the request includes the entropy received from the external source.

### TECHNICAL FIELD

This disclosure relates to random number generation and more specifically to providing entropy for random number generation.

### BACKGROUND

Random number generators (RNGs) are algorithms or computer-implemented techniques implemented to generate random numbers. Random numbers, in turn, are used in cryptography and computer security protocols such as Hypertext Transfer Protocol Secure (HTTPS), secure sockets layer (SSL) protocol, secure shell or secure socket shell (SSH) key pairs, to name a few. RNGs use entropy to generate random numbers. An entropy is a measure of randomness or disorder. In computing, entropy is a string of data (i.e., a certain number of bytes of data) that is collected by an operating system or application and provided to RNGs. The operating system obtains entropy from sources that interact with the operating system and whose interactions inherently result in randomness, e.g., peripherals (e.g., interrupts), CPU (e.g., context switches), memory (e.g., page faults), to name a few.

Virtual machines are computer resources that use software instead of physical computers to run programs and deploy applications. Virtual machines can deploy cryptography or computer security programs or applications. To do so, virtual machines can either consume entropy to implement RNGs or receive random numbers generated by RNGs. A hypervisor (or a virtual machine monitor) is software that creates and runs virtual machines. A hypervisor is separated into a kernel space and a user space. An entropy storage medium (called an entropy pool) is deployed in the kernel space, and can transfer entropy to virtual machines that are operatively coupled to the hypervisor. Entropy from entropy sources, such as those described above, can be routed to and stored in the entropy storage medium.

### SUMMARY

This disclosure describes computer-implemented methods, computer-readable storage medium and computer systems to populate entropy pools with entropy from external sources, i.e., sources that are external to the hypervisor deployed to manage operation of virtual machines.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic of an example of a computer system.

FIG. 2 is a flowchart of an example of a process of populating an entropy storage medium.

FIG. 3 is a flowchart of an example of a process of using entropy during a boot task.

FIG. 4 is a flowchart of an example of a process of repopulating the cache that stores entropy from internal sources.

FIG. 5 is a flowchart of an example of a process of providing entropy to a virtual machine.

Like reference numbers and designations in the various drawings indicate like elements.

### DETAILED DESCRIPTION

Entropy used in RNGs to generate random numbers is expected to satisfy certain security standards (e.g., EAL4) to ensure true randomness. Entropy can be received from internal entropy sources, i.e., sources that are internal to the computer system from which the entropy is received. Examples of such internal entropy sources include interrupts that happen at different instances such as when keys are typed on a keyboard, when a mouse (or other input device) is moved, when network packets are retrieved, when hard drive assembly moves, during disk seeks etc. Proving randomness of such entropy, i.e., proving that the entropy from such internal sources is sufficiently random to satisfy the security standards, can be difficult.

This disclosure describes obtaining entropy from one or more of multiple external entropy sources, i.e., entropy sources that are external but operatively coupled to the computer system, and combining the entropy from such sources to entropy obtained from internal entropy sources to generate entropy to be provided to client computer systems. Each external source is known, i.e., certified, to generate entropy that satisfies one or more security standards. By receiving entropy from such external sources and mixing the entropy received from external sources with entropy received from internal sources, overall randomness of the entropy can be improved, for example, to the level required by security standards. Reliability of random numbers generated using such entropy can be increased, and improved efficiencies in cryptography and computer security can be achieved.

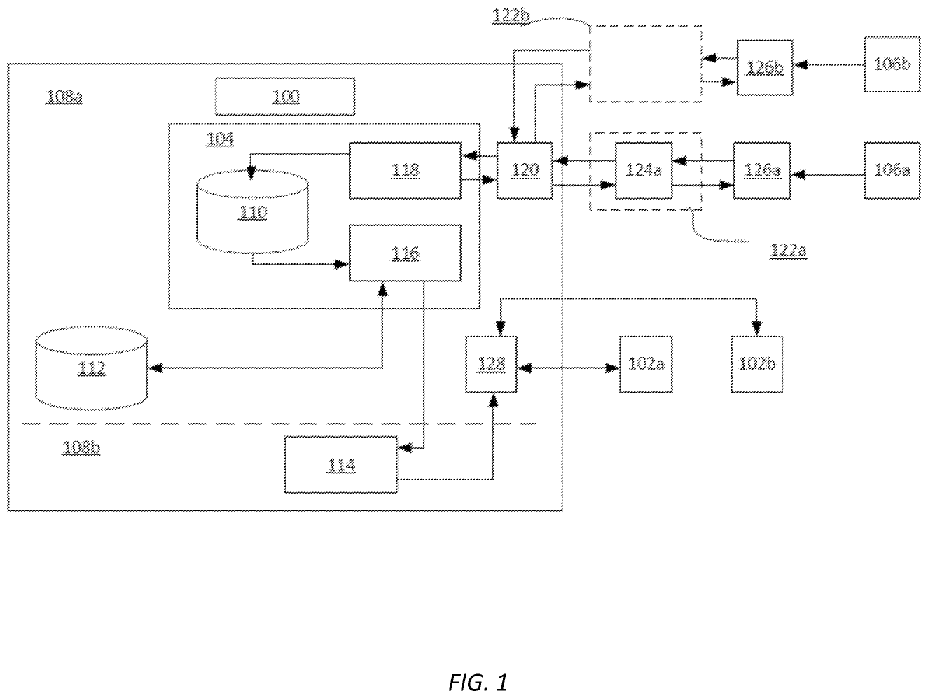

FIG. 1 is a schematic of an example of a computer system 100. The computer system 100 can be a hypervisor deployed to serve virtual machines (e.g., a first virtual machine 102a, a second virtual machine 102b, and more or fewer virtual machines). The hypervisor includes an integrated operating system components necessary to deploy the computer system 100.

The computer system 100 includes (i.e., deploys and executes) a daemon component 104. For example, the daemon component 104 is deployed as computer instructions executable by the computer system 100 or by processors dedicated to the daemon component 104. In some implementations, the daemon component 104 (sometimes called entropy daemon) is operatively coupled to multiple internal entropy sources, i.e., sources that are internal to the computer system 100. The daemon component 104 generates entropy, i.e., a random string of bytes, and outputs the entropy for consumption by the virtual machines that are external to the computer system 100.

The daemon component 104 is also operatively coupled to one or more external entropy sources (e.g., a first external entropy source 106a, a second external entropy source 106b or more or fewer external entropy sources). Each external entropy source is external to (i.e., not an internal component of) the computer system 100 and is operatively coupled to the computer system 100, specifically to the daemon component 104. Each external entropy source is configured to provide (as output) entropy that satisfies known security standards (e.g., NIST SP 800-90C, AIS 20/31). Each external entropy source is configured to transmit the entropy to the daemon component 104 by implementing a push function. That is, each external entropy source is configured to periodically output entropy without receiving a request for entropy from a requesting source such as the daemon component 104.

The computer system 100 is partitioned into a user space 108a and a kernel space 108b. The kernel space 108b runs the operating system kernel, kernel extensions and some device drivers of the computer system 100. The user space 108a is a separate portion of the computer system 100 in which application software and some device drivers execute. Data and signals can flow between the user space 108a and the kernel space 108b, but the two spaces operate independently of each other. In some implementations, the daemon component 104 is deployed in the user space 108a. In some implementations, the daemon component 104 can be deployed in the kernel space 108b.

The daemon component 104 includes a first cache 110 (called an in-memory cache) that stores entropy received from the external sources. For example, the first cache 110 can be implemented as a computer-readable storage medium configured to store data (e.g., bytes of data). The first cache 110 is dedicated to store entropy from external sources, but not internal sources. The computer system 100 includes a second cache 112 (called in-storage cache) that stores entropy received from internal sources. Like the first cache 110, the second cache 112 can also be implemented as a computer-readable storage medium configured to store data (e.g., bytes of data). The second cache 112 is dedicated to store entry from internal sources, but not external sources. In addition, the second cache 112 resides outside the daemon component 104 and can exchange data and communication with the daemon component 104. In some implementations, the in-memory cache and in-storage cache are dedicated to storing external entropy. Whereas internal entropy is not bound, external entropy is, and is cached for networking reasons. In some implementations, the in-storage cache can reside within the entropy daemon and the in-memory cache can reside outside the entropy daemon, e.g., in the ESXi host.

In some implementations, an entropy storage medium 114 (called an entropy pool) is deployed in the kernel space 108b. The daemon component 104 and the entropy storage medium 114 are operatively coupled to each other. In operation, the daemon component 104 can transmit entropy to the entropy storage medium 114. The entropy storage medium 114 can transmit a request for entropy to the daemon component 104. Alternatively or in addition, the daemon component 104 can deploy a polling mechanism using which the daemon component 104 can determine if a quantity of entropy in the entropy storage medium 114 satisfies a threshold quantity. The daemon component 104 can implement operations in response to determining if the entropy storage medium 110 stores at least the threshold quantity of entropy or not.

In some implementations, the daemon component 104 can deploy an update component 116, for example, as computer instructions stored on a computer-readable storage medium and executable by the daemon component 104. For example, the update component 116 can deploy the polling mechanism, described above, to determine if a quantity of entropy in the entropy storage medium 114 satisfies the threshold quantity. In some implementations, the update component 116 can receive the request for entropy from the entropy storage medium 114 and initiate computer-implemented processes to respond to the request. As described later, the response can include transmitting entropy stored either in the first cache 110 or in the second cache 112. In addition, the update component 116 can write entropy to the entropy storage medium 114. Also, in some implementations, the update component 116 can track a quantity of entropy stored in the first cache 110 and in the second cache 112. If the update component 116 determines that the quantity of externally sourced entropy in the first cache 110 is below a threshold quantity, then the update component 116 can trigger an action to cause the daemon component 104 to receive entropy being pushed by one or more of the external sources. If the update component 116 determines that the quantity of internally sourced entropy in the second cache is below a threshold quantity, then the update component 116 can trigger an action to cause the second cache 112 to receive entropy from internal sources. If the update component 116 determines that the quantity of entropy in the second cache 112 is below a threshold and that entropy from the second cache 112 is needed to implement an operation, then the update component 116 can trigger transmission of entropy from the first cache 110 to the second cache 112 while the second cache 112 is being re-populated with entropy from internal sources.

In some implementations, the daemon component 104 includes (i.e., deploys) an application programming interface (API) endpoint 118 through the daemon component 104 receives entropy from the external sources. The API endpoint 118 is also configured to query the first cache 110. As described above, the external devices transmit entropy via a push methodology in which the external devices are periodically transmitting entropy even without a request for entropy from the computer system 100. However, the first cache 110 has a storage limit on the amount of externally sourced entropy that the first cache 110 can store. By querying the first cache 110, the API endpoint 118 can determine if the first cache 110 is at or near the storage limit or if the first cache 110 can receive and store entropy from the external devices. Based on a result of the determination, the API endpoint 118 can either receive the entropy from the external devices or throttle the entropy flow to hold or limit entropy transmission from the externally sourced devices to the first cache 110. In some implementations, the API endpoint 118 receives the externally sourced entropy in a first format, e.g., binary data format. The daemon component 104 is configured to consume and transmit entropy in a second format that is different from the first format, e.g., in a JSON format. The API endpoint 118 is configured to convert the entropy from the external source from the first format into the second format. In general, the external sources can transmit entropy to the daemon component 104 in respective formats that are different from each other. The API endpoint 118 can determine the format in which the entropy from an external source is received, determine if the format of the received entropy needs to be modified into the format in which the daemon component 104 consumes and transmits the entropy, and modify the format of the externally sourced entropy as needed. In some implementations, converting the format of the entropy data can include converting the entropy in any format into a base64 encoding, and converting the base64 encoded entropy into another format.

In some implementations, the daemon component 104 deploys a secure channel (e.g., a first secure channel 122a, a second secure channel 122b—one per external entropy source—through which the external entropy source securely transmits entropy to the daemon component 104. For example, the computer system 100 can implement an authentication protocol, e.g., similar to trusted platform module (TPM) technology, in the secure channel to receive the entropy from the external source. Because the external entropy originates external to the computer system 100, transmission through the secure channel ensures integrity of the entropy received from the external source. Each secure channel includes a virtual client (VC) (e.g., VC 124a in secure channel 122a) to receive entropy from the external source (the external device 106a, in this example). For example, the VC can receive the entropy from the external source via a device input and output control (IOCTL) interface. More generally, the computer system 100 can implement IOCTL to exchange (i.e., transmit or receive) entropy between components. The VC serves as an API interface to the external entropy source and forwards all entropy requests to the computer system 100.

The computer system 100 includes (i.e., deploys) an API forwarder component 120 that serves as an interface between the API endpoint 118 deployed by the daemon component 104 and the external environment from which the entropy from the external devices are received. An entropy client (e.g., a first entropy client 126a for the first external entropy source 106a, a second entropy client 126b for the second external entropy source 106b, and so on) is deployed as a service, e.g., on a Linux virtual machine. The entropy client executes a script with rest API calls that act as intermediaries between the respective external entropy device and the computer system 100, specifically the VC 124a. Each entropy client gets entropy data from the respective external entropy source and pushes the entropy data to the VC in the secure channel via rest APIs.

In an example operation, the external entropy source 106a transmits, via a push methodology, entropy via its respective entropy client 126b to the VC 124a. The VC 124a receives the entropy via the entropy client 126b via the secure channel 122a. The VC 124a, the API forwarder component 120 and the API endpoint 118 exchange requests and responses including requests to transmit or receive entropy from the external source 106a, and responses to the requests. When the API endpoint 118 determines that the quantity of entropy in the first cache 110 is below a threshold, then the API endpoint 118 receives entropy from the external entropy source 106a via the secure channel 122a. On the other hand, if the API endpoint 118 determines that the quantity of entropy in the first cache 110 is at the threshold, then the API endpoint 118 throttles the flow of the entropy from the external entropy source 106a. In some implementations, the API endpoint 118 can receive a request for entropy of a specific format or satisfying a specific security standard (or both), identify one or more external entropy sources that can satisfy the requirements, and open the secure channel (or channels) to the identified external entropy source (or sources) while keeping other secure channels to other external entropy sources closed.

The update component 116 in the daemon component 104 receives a request from the entropy storage medium 114 for entropy. Alternatively or in addition, the update component 116 polls the entropy storage medium 114 for entropy. In response, and depending on operational conditions (discussed later), the update component 116 can draw entropy from the first cache 110 alone or from the first cache 110 and the second cache 112, and transmit the entropy to the entropy storage medium 114, e.g., via IOCTL. For example, the entropy storage medium 114 can transmit the request for entropy to the update component 104 because the virtual machine 102a transmitted a request to the entropy storage medium 114 for the entropy. For example, the user space 108a can implement a hypercall component 128 through which the entropy storage medium 114, in the kernel space 108b, can receive the request from the virtual machine 102a. In response, the computer system 100 can transmit entropy, which includes the entropy from the external source, to the virtual machine 102a. The virtual machine 102a (or any other client that requested and received the entropy including the entropy from the external source or sources) can use the received entropy in RNG algorithms to generate random numbers.

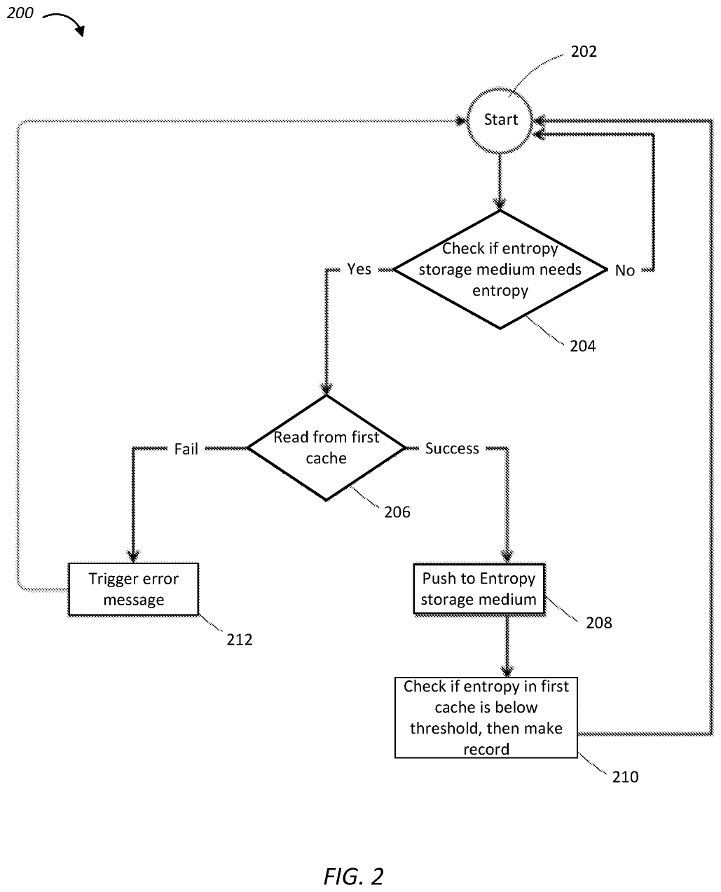

FIG. 2 is a flowchart of an example of a process 200 of populating an entropy storage medium, e.g., the entropy storage medium 114 (FIG. 1), and of periodically updating the entropy storage medium 114 with entropy received from an external source. The process 200 starts at 202. For example, the process 200 can be implemented by the daemon component 104, specifically by the update component 116. At 204, the daemon component 104 can check if the entropy storage medium 114 needs entropy. For example, the daemon component 104 can compare a quantity of entropy stored in the entropy storage medium 114 with a threshold quantity that the entropy storage medium 114 must store. If the daemon component 104 determines at 204 that the entropy storage medium 114 does not need entropy (decision branch “NO”), then the process 200 loops back and starts again at 202. If the daemon component 104 determines that the entropy storage medium 114 does need entropy (decision branch “YES”), then, at 206, the daemon component 104 attempts to read entropy from the first cache 110 (called in-memory cache), i.e., the cache that stores entropy received from external sources. If the daemon component 104 successful reads and obtains entropy from the in-memory cache (decision branch “SUCCESS”), then, at 208, the daemon component 104 pushes the entropy read from the in-memory cache to the entropy storage medium 114, e.g., using an IOCTL. Then, at 210, the daemon component 104 checks if entropy in the first cache 110 (i.e., the in-memory cache) is below a threshold, and makes a record of the determination. Returning to step 206, if the daemon component 104 fails to read entropy from the in-memory cache (decision branch “FAIL”), then, at 212, the daemon component 104 triggers an error message and returns to start at 202.

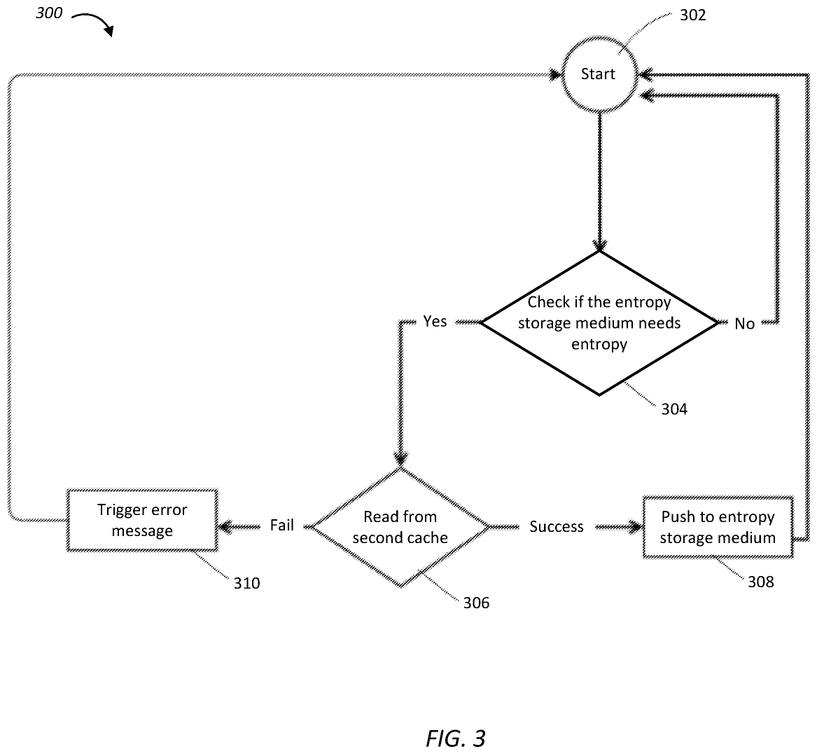

FIG. 3 is a flowchart of an example of a process 300 of using entropy during a boot task. The process 200 described with reference to FIG. 2 is implemented in all sequences except during a boot sequence, i.e., when performing a boot task. When the boot task performed, entropy from an external source cannot be used to populate the entropy storage medium 114. The process 300 starts at 302. For example, the process 300 can be implemented by the daemon component 104, specifically by the update component 116. At 304, the daemon component 104 can check if the entropy storage medium 114 needs entropy. For example, the daemon component 104 can compare a quantity of entropy stored in the entropy storage medium 114 with a threshold quantity that the entropy storage medium 114 must store during boot sequence. If the daemon component 104 determines that the entropy storage medium 114 does not need entropy (decision branch “NO”), then the process 300 loops back and starts again at 302. If the daemon component 104 determines that the entropy storage medium 114 does need entropy (decision branch “YES”), then, at 304, the daemon component 104 attempts to read entropy from the second cache 112 (called in-memory cache), i.e., the cache that stores entropy received from internal sources. In particular, during the boot sequence, the daemon component 104 does not use entropy stored in the first cache 110, i.e., the cache that stores entropy from external sources. If the daemon component 104 successful reads and obtains entropy from the in-storage cache (decision branch “SUCCESS”), then, at 308, the daemon component 104 pushes the entropy read from the in-storage cache to the entropy storage medium 114, e.g., using an IOCTL. If the daemon component 104 fails to read entropy from the in-storage cache (decision branch “FAIL”), then, at 310, the daemon component 104 triggers an error message and returns to start at 302.

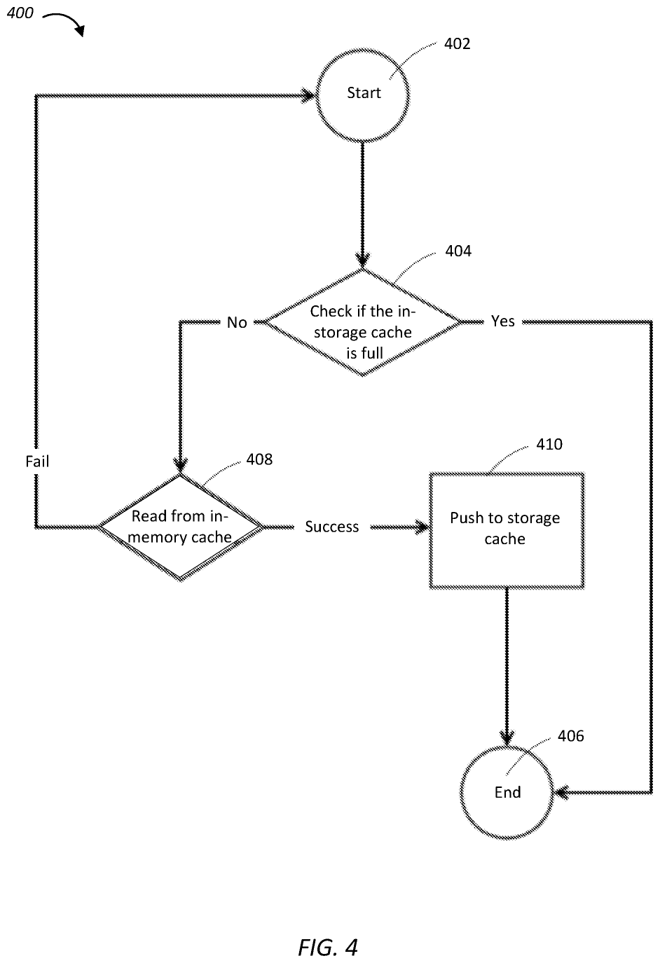

FIG. 4 is a flowchart of an example of a process 400 of repopulating the cache that stores entropy from internal sources, i.e., the second cache 112 (FIG. 1) also called the in-storage cache. The process 400 starts at 402. For example, the process 400 can be implemented by the daemon component 104, specifically by the update component 116. At 404, the daemon component 104 checks if the in-storage cache, i.e., the second cache 112 that stores entropy from internal sources, is full. For example, the daemon component 104 can compare a quantity of entropy stored in the in-storage cache (i.e., the second cache 112) with a threshold quantity that the in-storage cache must store. If the daemon component 104 determines that the quantity of entropy stored in the in-storage cache meets the threshold quantity (decision branch “YES”), then the process 400 ends at 406. If the daemon component 104 determines that the quantity of entropy stored in the in-storage cache does not meet the threshold quantity (decision branch “NO”), then, at 408, the daemon component 104 checks to read entropy from the in-memory cache, i.e., the first cache 110 that stores entropy from external sources. If the daemon component 104 successfully reads entropy from the in-memory cache (decision branch “Success”), then, at 410, the daemon component 104 pushes entropy from the in-memory cache to the in-storage cache until the quantity of the entropy in the in-storage cache meets or exceeds the threshold quantity. Then, the process ends at 406. Returning to step 408, if the daemon component 104 is unable to read entropy from the in-memory cache (decision branch “Fail”), then the process 400 returns to the start at 402.

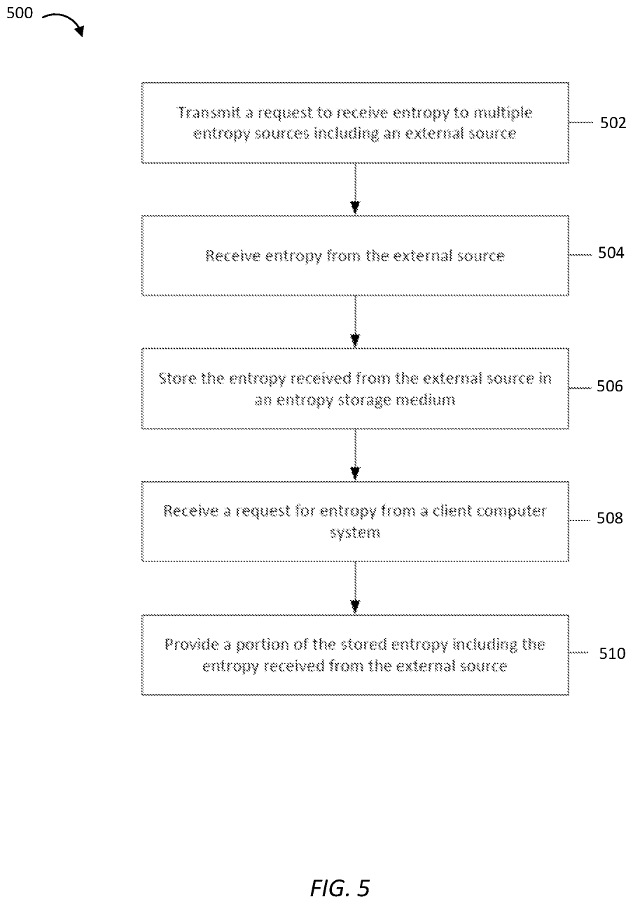

FIG. 5 is a flowchart of an example of a process 500 of providing entropy to a virtual machine. The process 500 can be implemented by the computer system 100, specifically by the daemon component 104. At 502, the computer system 100 transmits a request to multiple entropy sources to receive entropy from the sources. At least one of the multiple sources is an external source that is external and operatively connected to the computer system 100. At 504, the computer system 100 receives entropy from the external source. At 506, the computer system 100 stores the entropy received from the external source in an entropy storage medium. At 508, the computer system receives a request from a client computer system (e.g., a virtual machine 102a) for entropy to be used by the virtual machine 102a to implement a random number generation algorithm. At 510, in response to receiving the request from the virtual machine 102a, the computer system 100 provides a portion of the stored entropy. The portion of the stored entropy which the computer system 100 provides includes the entropy received from the external source.

Certain aspects of the subject matter described here can be implemented as a computer-implemented method. A computer system transmits, to multiple entropy sources, a request to receive entropy. At least one of the multiple entropy sources is an external source that is external and operatively connected to the computer system. The computer system receives entropy from the external source. The computer system stores the entropy received from the external source in an entropy storage medium. The computer system receives, from a client computer system, a request for entropy to be used by the client computer system to implement a random number generation algorithm. In response to receiving the request, the computer system provides a portion of the stored entropy. The portion of the stored entropy provided in response to receiving the request includes the entropy received from the external source.

An aspect combinable with any other aspect includes the following features. Entropy from the external source is received in a first format and converted into a second format in which the entropy from the external source is to be stored in the entropy storage medium.

An aspect combinable with any other aspect includes the following features. The first format is a binary data format. The second format is a Json format. To convert the entropy from the external source from the first format into the second format, the binary data format is converted into a base64 encoding, and the base 64 encoding is converted into the Json format.

An aspect combinable with any other aspect includes the following features. To receive the entropy from the external source, a secure channel is deployed to transfer the entropy from the external source to the entropy storage medium. The entropy is transferred from the external source to the entropy storage medium via the secure channel.

An aspect combinable with any other aspect includes the following features. The computer system is partitioned into a user space and a kernel space. The entropy storage medium is hosted in the kernel space. To store the entropy received from the external source in an entropy storage medium, the entropy received from the external source is stored in a cache hosted in the user space. At the cache hosted in the user space, a request is received for the entropy from the entropy storage medium. In response to receiving the request at the cache hosted in the user space, the entropy received from the external source is transmitted from the cache hosted in the user space to the entropy storage medium hosted in the kernel space.

An aspect combinable with any other aspect includes the following features. The computer system determines that a quantity of entropy in the entropy storage medium is below a threshold entropy quantity. In response, the computer system transmits the request to receive entropy to the multiple entropy sources.

An aspect combinable with any other aspect includes the following features. The computer system determines that a sequence in which the request to receive entropy is transmitted is a boot-up sequence. In response, the entropy from the external source is excluded, and entropy from a cache hosted in the user space is received. All entropy stored in the cache is received from an entropy source that is internal to the computer system.

Certain aspects of the subject matter described in this disclosure can be implemented as a system that includes one or more processors including a hardware-based processor, and a memory storage including a non-transitory computer-readable medium storing instructions which, when executed by the one or more processors including the hardware-based processor, to perform operations including the methods described in this disclosure.

While this specification contains many specific implementation details, these should not be construed as limitations on the scope of any implementation or on the scope of what may be claimed, but rather as descriptions of features that may be specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In certain implementations, multitasking and parallel processing can be advantageous.

1. A computer-implemented method comprising:
transmitting, by a computer system and to a plurality of entropy sources, a request to receive entropy, wherein at least one of the plurality of entropy sources is an external source that is external and operatively connected to the computer system;
receiving, by the computer system, entropy from the external source;
storing, by the computer system, the entropy received from the external source in an entropy storage medium;
receiving, by the computer system and from a client computer system, a request for entropy to be used by the client computer system to implement a random number generation algorithm; and
in response to receiving the request, providing, by the computer system, a portion of the stored entropy, wherein the portion of the stored entropy provided in response to receiving the request includes the entropy received from the external source.

2. The computer-implemented method of claim 1, wherein receiving the entropy from the external source comprises:
receiving the entropy from the external source in a first format; and
converting the entropy from the external source from the first format into a second format in which the entropy from the external source is to be stored in the entropy storage medium.

3. The computer-implemented method of claim 2, wherein the first format is a binary data format, and the second format is a Json format, wherein converting the entropy from the external source from the first format into the second format comprises:
converting the binary data format into a base64 encoding; and
converting the base 64 encoding into the Json format.

4. The computer-implemented method of claim 1, wherein receiving the entropy from the external source comprises:
deploying a secure channel to transfer the entropy from the external source to the entropy storage medium; and
transferring the entropy from the external source to the entropy storage medium via the secure channel.

5. The computer-implemented method of claim 1, wherein the computer system is partitioned into a user space and a kernel space, wherein the entropy storage medium is hosted in the kernel space, wherein storing the entropy received from the external source in an entropy storage medium comprises:
storing the entropy received from the external source in a cache hosted in the user space;
receiving, at the cache hosted in the user space, a request for the entropy from the entropy storage medium; and
in response to receiving, at the cache hosted in the user space, the request for the entropy from the entropy storage medium, transmitting the entropy received from the external source from the cache hosted in the user space to the entropy storage medium hosted in the kernel space.

6. The computer-implemented method of claim 1, further comprising:
determining, by the computer system, that a quantity of entropy in the entropy storage medium is below a threshold entropy quantity; and
in response to determining that the quantity of entropy is below the threshold entropy quantity, transmitting, by the computer system and to the plurality of entropy sources, the request to receive entropy.

7. The computer-implemented method of claim 1, further comprising:
determining, by the computer system, that a sequence in which the request to receive entropy is transmitted is a boot-up sequence;
in response to determining, by the computer system, that the sequence is the boot-up sequence:
excluding entropy received from the external source; and
receiving entropy from a cache hosted in the user space, wherein all entropy stored in the cache is received from an entropy source that is internal to the computer system.

8. A non-transitory computer-readable medium storing instructions which, when executed by a hardware-based processor, performs operations comprising:
transmitting, to a plurality of entropy sources, a request to receive entropy, wherein at least one of the plurality of entropy sources is an external source that is external and operatively connected to a computer system from which the request is transmitted;
receiving entropy from the external source;
storing the entropy received from the external source in an entropy storage medium;
receiving, from a client computer system, a request for entropy to be used by the client computer system to implement a random number generation algorithm; and
in response to receiving the request, providing a portion of the stored entropy, wherein the portion of the stored entropy provided in response to receiving the request includes the entropy received from the external source.

9. The medium of claim 8, wherein receiving the entropy from the external source comprises:
receiving the entropy from the external source in a first format; and
converting the entropy from the external source from the first format into a second format in which the entropy from the external source is to be stored in the entropy storage medium.

10. The medium of claim 9, wherein the first format is a binary data format, and the second format is a Json format, wherein converting the entropy from the external source from the first format into the second format comprises:
converting the binary data format into a base64 encoding; and
converting the base 64 encoding into the Json format.

11. The medium of claim 8, wherein receiving the entropy from the external source comprises:
deploying a secure channel to transfer the entropy from the external source to the entropy storage medium; and
transferring the entropy from the external source to the entropy storage medium via the secure channel.

12. The medium of claim 8, wherein the computer system is partitioned into a user space and a kernel space, wherein the entropy storage medium is hosted in the kernel space, wherein storing the entropy received from the external source in an entropy storage medium comprises:
storing the entropy received from the external source in a cache hosted in the user space;
receiving, at the cache hosted in the user space, a request for the entropy from the entropy storage medium; and
in response to receiving, at the cache hosted in the user space, the request for the entropy from the entropy storage medium, transmitting the entropy received from the external source from the cache hosted in the user space to the entropy storage medium hosted in the kernel space.

13. The medium of claim 8, wherein the operations further comprise:
determining, by the computer system, that a quantity of entropy in the entropy storage medium is below a threshold entropy quantity; and
in response to determining that the quantity of entropy is below the threshold entropy quantity, transmitting, by the computer system and to the plurality of entropy sources, the request to receive entropy.

14. The medium of claim 8, wherein the operations further comprise:
determining, by the computer system, that a sequence in which the request to receive entropy is transmitted is a boot-up sequence;
in response to determining, by the computer system, that the sequence is the boot-up sequence:
excluding entropy received from the external source; and
receiving entropy from a cache hosted in the user space, wherein all entropy stored in the cache is received from an entropy source that is internal to the computer system.

15. A computer system comprising:
one or more processors including a hardware-based processor; and
a memory storage including a non-transitory computer-readable medium storing instructions which, when executed by the one or more processors including the hardware-based processor, performs operations comprising:
transmitting, to a plurality of entropy sources, a request to receive entropy, wherein at least one of the plurality of entropy sources is an external source that is external and operatively connected to the computer system;
receiving entropy from the external source;
storing the entropy received from the external source in an entropy storage medium;
receiving, from a client computer system, a request for entropy to be used by the client computer system to implement a random number generation algorithm; and
in response to receiving the request, providing a portion of the stored entropy, wherein the portion of the stored entropy provided in response to receiving the request includes the entropy received from the external source.

16. The system of claim 15, wherein receiving the entropy from the external source comprises:
receiving the entropy from the external source in a first format; and
converting the entropy from the external source from the first format into a second format in which the entropy from the external source is to be stored in the entropy storage medium.

17. The system of claim 16, wherein the first format is a binary data format, and the second format is a Json format, wherein converting the entropy from the external source from the first format into the second format comprises:
converting the binary data format into a base64 encoding; and
converting the base 64 encoding into the Json format.

18. The system of claim 15, wherein receiving the entropy from the external source comprises:
deploying a secure channel to transfer the entropy from the external source to the entropy storage medium; and
transferring the entropy from the external source to the entropy storage medium via the secure channel.

19. The system of claim 15, wherein the computer system is partitioned into a user space and a kernel space, wherein the entropy storage medium is hosted in the kernel space, wherein storing the entropy received from the external source in an entropy storage medium comprises:
storing the entropy received from the external source in a cache hosted in the user space;
receiving, at the cache hosted in the user space, a request for the entropy from the entropy storage medium; and
in response to receiving, at the cache hosted in the user space, the request for the entropy from the entropy storage medium, transmitting the entropy received from the external source from the cache hosted in the user space to the entropy storage medium hosted in the kernel space.

20. The system of claim 15, wherein the operations further comprise:
determining, by the computer system, that a quantity of entropy in the entropy storage medium is below a threshold entropy quantity; and
in response to determining that the quantity of entropy is below the threshold entropy quantity, transmitting, by the computer system and to the plurality of entropy sources, the request to receive entropy.
